(19) United States
(12) Patent Application Publication
(10) Pub. No.: US 2025/0361463 A1
(43) Pub. Date: Nov. 27, 2025

(54) A Dishwashing Detergent Composition, A Water-Soluble Container, and an Autodosing Automatic Dishwashing System

(71) Applicant: Reckitt Benckiser Finish B.V., Hoofddorp (NL)

(72) Inventors: Alias Younis Al-Bayati, Heidelberg (DE); Torsten ROTH, Heidelberg (DE); Jan Maurycy USZKO, Heidelberg (DE); Divya VARADHARAJAN, Heidelberg (DE); Nils WEDLER, Heidelberg (DE); Qingcai ZHAO, Heidelberg (DE)

(21) Appl. No.: 18/874,431

(22) PCT Filed: Jun. 23, 2023
(86) PCT No.: PCT/EP2023/067194

§ 371 Date: Dec. 12, 2024

(30) Foreign Application Priority Data
Jun. 29, 2022 (GB) 2209521.0

(51) Int. Cl. C11D 1/00; C11D 17/04

(52) U.S. Cl. CPC C11D 1/008; C11D 17/045

(57) ABSTRACT

The present invention is related to a dishwashing, preferably an automatic dishwashing, detergent composition; wherein the detergent composition comprises a water-soluble polyester.

The present invention is also related to a dishwashing, preferably an automatic dishwashing, water-soluble container wherein said water-soluble container is made of a thermoformed water-soluble film comprising poly (vinyl alcohol) and wherein said water-soluble container is at least partially filled with such an inventive dishwashing, preferably an automatic dishwashing, detergent composition.

### FIELD OF THE INVENTION

The present invention relates to a dishwashing detergent composition.

The present invention is also directed to a dishwashing water-soluble container and an autodosing automatic dishwashing system.

### BACKGROUND OF THE INVENTION

Although automatic dishwashing (ADW) detergents provide commonly an excellent cleaning performance, shine performance and material care for standard dishes and cutlery pieces such as stainless steel, porcelain, and glass; the protection and care of plastic items is only addressed to a limited extent.

With a traditional strong focus on cleaning and shine performance in the ADW detergents, it is recently becoming important to be able to provide additional special benefits for consumers. In this aspect, consumers often face problems with plastics, both with respect to their in-wash staining or discoloration and their inefficient drying.

Herein, the hydrophobic surfaces of plastic boxes and their lids, cutting boards, and plates face the problem that the plastics after a washing cycle appear more stained than before when placed by consumers in the dishwasher. This is arising from the transfer and redeposition of chromophoric soils that are present in common foods such as tomato sauce or curry: carotenes (e.g., lycopene) or curcumin. On a molecular level it is believed that the strong attraction between the hydrophobic nature of staining substances and plastic surfaces (e.g., poly-propylene) is the driving force for this process that causes the migration of the stains into the plastic items.

WO04003124 discloses the use of low and high molar mass vinylpyrrolidone copolymers as a finishing aid for surface hydrophilization in an ADW composition. The polymers are said to be beneficial for overall surface care of dishes, including, but not limited to shine, feel, sensory, filming, or inhibition of food stain deposition.

Although bleach has been attempted for use as a traditional solution to remove red stains from a surface, its effect is known to be minimal, and in some cases even detrimental, in preventing plastic discoloration due to existing stains in a dishwasher cycle.

Other solutions such as use of polymers have also not been satisfactory until today, making it a challenge but also a necessity in ADW detergent formulations.

### OBJECTIVE OF THE PRESENT INVENTION

In view of the prior art, it was thus an object of the present invention to provide a dishwashing, preferably an automatic dishwashing, detergent composition, which shall not exhibit the aforementioned shortcomings of the known prior art dishwashing detergent compositions.

In particular, it was an object of the present invention to provide a dishwashing detergent composition which shall be able to be used for the prevention of discoloration of plastic dishes during a dishwashing, preferably during an automatic dishwashing, process.

Additionally, it was especially an object of the present invention to provide a dishwashing detergent composition, which is suitable for an application as a monodose detergent product as well as for an application as a dishwashing detergent composition for autodosing automatic dishwashing processes.

### SUMMARY OF THE INVENTION

These objects and also further objects which are not stated explicitly but are immediately derivable or discernible from the connections discussed herein by way of introduction are achieved by a dishwashing detergent composition having all features of claim 1. Appropriate modifications to the inventive dishwashing detergent composition are protected in dependent claims 2 to 11. Further, claim 12 relates to a dishwashing water-soluble container, while claim 13 is an appropriate modification thereof. Claim 14 relates to an autodosing automatic dishwashing system, while claim 15 is related to a use of such an inventive detergent composition for the prevention of discoloration of plastic dishes during a dishwashing process.

The present invention accordingly provides a dishwashing, preferably an automatic dishwashing, detergent composition characterized in that the detergent composition comprises a water-soluble polyester.

It is thus possible in an unforeseeable manner to provide a dishwashing, preferably an automatic dishwashing, detergent composition, which does not exhibit the aforementioned shortcomings of the known prior art dishwashing detergent compositions.

In particular, the inventive dishwashing detergent composition is able to be used for the prevention of discoloration of plastic dishes during a dishwashing, preferably during an automatic dishwashing, process.

Additionally, it was especially an object of the present invention to provide a dishwashing detergent composition, which is suitable for an application as a monodose detergent product as well as for an application as a dishwashing detergent composition for autodosing automatic dishwashing processes.

By “monodose”, it is meant that the product comprises one or more compositions in the quantity required for a single wash cycle of a machine dishwasher.

### BRIEF DESCRIPTION OF THE TABLES

Objects, features, and advantages of the present invention will also become apparent upon reading the following description in conjunction with the tables, in which:

Table 1 exhibits a comparison of comparative and inventive formulations.

Table 2 exhibits a comparison of further comparative and inventive formulations.

Table 3 exhibits information about the polymers used in the comparative and inventive formulations of Tables 1 and 2.

### DETAILED DESCRIPTION OF THE INVENTION

In a preferred embodiment, the water-soluble polyester is a water-soluble aromatic polyester.

In one embodiment thereof, said water-soluble aromatic polyester is obtained by a reaction of at least one diol with at least one aromatic diacid or a derivative thereof.

In another embodiment thereof, said water-soluble aromatic polyester is obtained by a reaction of at least one diol with at least two different aromatic diacid or derivatives thereof.

As used herein, the term “derivatives”, when applied to an aromatic diacid in accordance with the present invention, refers to the substitution of at least one of the two carboxylic acid groups of the respective aromatic diacid by an anhydride group, an ester group, a carboxylic acid salt, or a carboxylic acid chloride. Especially preferred is a substitution of at least one of the two carboxylic acid groups of the respective aromatic diacid by a methyl ester group or by two methyl ester groups.

In one embodiment, said at least one diol is selected from the group consisting of ethylene glycol, propylene glycol, butylene glycol, polyethylene glycol, polypropylene glycol and polybutylene glycol.

In one embodiment, said at least one aromatic diacid derivative comprises one or two ester groups, one or two anhydride groups, one or two carboxylic acid salt groups, and/or one or two carboxylic acid chloride groups instead of one or two respective carboxylic acid groups of the respective aromatic diacid; wherein preferably said at least one aromatic diacid derivative comprises at least one or two methyl ester groups instead of one or two respective carboxylic acid groups of the respective aromatic diacid.

In one embodiment, said water-soluble aromatic polyester comprises at least one substitution of at least one hydrogen atom at the aromatic ring, preferably in 5-position, by one sulfate group, by one sulfonic acid group, or by one anionic sulfonic acid group with a respective suitable counterion.

As used herein, the term “suitable counterion” refers to a monovalent, divalent or trivalent cation. That suitable counterion shall ensure compensation or equalization of the negative charges comprised in said polyester provided by the at least one anionic sulfonic acid group, which is the respective negatively charged deprotonated sulfonic acid group. Herein, sodium ions, ammonium ions, zinc ions and bismuth ions are especially preferred as suitable counterions.

In one embodiment, said at least one aromatic diacid or a derivative thereof is selected from the group consisting of terephthalic acid, isoterepthalic acid, isophthalic acid, phthalic acid, 5-sulfoisophthalic acid, 5-sulfoisoterephthalic acid, 5-sulfoterephthalic acid, and 5-sulfophthalic acid.

In a preferred embodiment thereof, one aromatic diacid or a derivative thereof of said at least one aromatic diacid or a derivative thereof is selected from the group consisting of 5-sulfoisophthalic acid, 5-sulfoisoterephthalic acid, 5-sulfoterephthalic acid, or 5-sulfophthalic acid.

In one embodiment, said polyester has a number average molecular weight ranging from 1000 to 50000 g/mol, preferably from 2500 to 25000 g/mol, and more preferably from 2500 to 12000 g/mol.

Herein, the number average molecular weight has been determined by the well-known standard process of gel permeation chromatography (GPC) measured against a polyethylenglycole (PEG) standard.

In one embodiment, said dishwashing, preferably automatic dishwashing, detergent composition comprises 0.5 to 10 wt %, preferably 1 to 7 wt %, and more preferably 1.2 to 4 wt % of said water-soluble polyester.

As used herein, the terms “wt %”, “% wt.”, “weight %”, and “% by weight” are synonyms to each other. All of these expressions are referring to a weight percentage of the respective component.

The dishwashing, preferably automatic dishwashing, detergent composition of the present invention can comprise a builder.

The builder may be a phosphate-free builder. In many countries, including the United States and in the European Union, phosphate builders are restricted, or the amount of phosphate permitted in a detergent composition has been severely limited. Therefore, in preferred embodiments, the detergent compositions are substantially phosphate-free.

The builder comprises one or more small molecule builders selected from hydroxycarboxylates (such as a citrate salt, for example trisodium citrate, which may be anhydrous), aminocarboxylates (such as methyl glycine diacetic acid (MGDA), or N,N-dicarboxymethyl glutamic acid (GLDA), dicarboxylic acid amines (such as iminodisuccinic acid (IDS)) and/or phosphates (such as tripolyphosphate), or the salts thereof.

The builder may be present in an amount of greater than 10% wt., 15% wt., 20% wt., 25% wt., 30 wt. %, 35% wt., 40% wt., 45% wt., or greater than 50% wt. The builder may be present in an amount between 31 and 49 wt. %, between 32 and 41% wt., or between 33 and 39% wt.

The builder may be present in an amount up to 0.1% wt., 0.2% wt., 0.3% wt., 0.4% wt., 0.5% wt., 0.6% wt., 0.7% wt., 0.8% wt., 0.9% wt., 1% wt., 1.5% wt., 2% wt., 3% wt., 4% wt., 5% wt., 6% wt., 7% wt., 8% wt., 9% wt. or up to 10% wt.

The actual amount used in the detergent composition may depend upon the nature of the builder used.

The builder may be an organic builder.

The detergent composition may comprise a secondary builder (co-builder), for example a phosphonate, such as tetrasodium-HEDP.

The dishwashing, preferably automatic dishwashing, detergent composition of the present invention can comprise at least one polymer, preferably at least one polycarboxylate. By the term ‘polycarboxylate’, we mean any polymeric species comprising a carboxylic acid or carboxylate groups available for chelation. The polycarboxylate polymer may be a homopolymer and/or a copolymer and/or a terpolymer.

The one or more polymer may be present in an amount of between 3 and 25% wt., between 5 and 20% wt., between 6 and 18% wt., between 7 and 16% wt., between 8 and 15% wt., or between 9 and 13% wt.

The polymer may be a polycarboxylate polymer comprising an itaconic acid copolymer.

The polymer may be a polycarboxylate polymer comprising an acrylic acid monomer.

The polymer may be a polycarboxylate polymer comprising an acrylic acid homopolymer. The homopolymer may have a number average molecular weight of between 2,000 and 10,000, between 3,000 and 9,000, or between 4,000 and 8,000. The homopolymer may be present in an amount of from 0.1 to 5% wt., from 0.2 to 4.5% wt., from 0.3 to 4% wt., from 0.3 to 3.5% wt., from 0.4 to 3% wt., from 0.5 to 2.5% wt., from 0.6 to 2% wt., or from 0.7 to 1.5% wt.

The at least one polycarboxylate may comprise a sulphonic acid monomer. The sulphonic acid monomer may be present in an amount of from 4 to 14% wt., from 5 to 13% wt., from 6 to 12% wt. or from 7 to 11% wt.

Preferred monomers containing sulphonic acid groups are those of the formula:

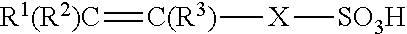

in which R¹ to R³ mutually independently denote —CH₃, a straight-chain or branched saturated alkyl residue with 2 to 12 carbon atoms, a straight-chain or branched, mono-or polyunsaturated alkenyl residue with 2 to 12 carbon atoms, alkyl or alkenyl residues substituted with —NH2, —OH or —COOH, or denote —COOH or —COOR⁴, R⁴ being a saturated or unsaturated, straight-chain or branched hydrocarbon residue with 1 to 12 carbon atoms, and X denotes an optionally present spacer group which is selected from —(CH₂)n- with n=0 to 4, —COO—(CH₂)k- with k=1 to 6, —C(O)—NH—C(CH₃)₂— and CH(CH₂CH₃)—.

Preferred monomers of the above formula include, for example, those of the formulae:

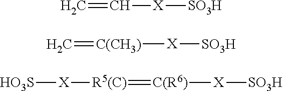

in which R⁵ and R⁶ are mutually independently selected from —H, —CH₃, —CH₂CH₃, —CH₂CH₂CH₃, —CH(CH₃)₂ and X denotes an optionally present spacer group which is selected from —(CH₂)n- with n=0 to 4, —COO—(CH₂)k with k=1 to 6, —C(O)—NH—C(CH₃)₂— and —C(O)—NH—CH(CH₂CH₃)—.

Preferred monomers containing sulphonic acid groups are here 1-acrylamido-1-propanesulphonic acid, 2-acrylamido-2-propanesulphonic acid, 2-acrylamido-2-methyl-1-propanesulphonic acid, 2-methacrylamido-2-methyl-1-propanesulphonic acid, 3-methacrylamido-2-hydroxypropane-sulphonic acid, allylsulphonic acid, methallylsulphonic acid, allyloxybenzenesulphonic acid, methallyloxybenzenesulphonic acid, 2-hydroxy-3-(2-propenyloxy)propanesulphonic acid, 2-methyl-2-propene-1-sulphonic acid, styrenesulphonic acid, vinylsulphonic acid, 3-sulphopropyl acrylate, 3-sulfopropyl methacrylate, sulphomethacrylamide, sulphomethylmethacrylamide and mixtures of the stated acids or the water-soluble salts thereof. Particularly preferred is 2-acrylamido-2-methyl-1-propane-sulphonic acid.

The sulphonic acid groups may be present in the polymers entirely or in part in neutralized form, i.e. the acidic hydrogen atom of the sulphonic acid group may be replaced in some or all of the sulphonic acid groups with metal ions, preferably alkali metal ions and in particular with sodium ions. It is preferred according to the invention to use copolymers containing partially or completely neutralized sulphonic acid groups.

The molar mass of the sulphonic acid polymers may be varied in order to tailor the properties of the polymers to the desired intended application. The copolymers may have a number average molecular weight of between 2000 and 200,000 g mol⁻¹, between 4000 and 25,000 g mol⁻¹, or between 5000 and 15,000 g mol⁻¹. The polymer preferably has a pH of from 3 to 5, such as from 3.5 to 4.5.

The polycarboxylate may be a copolymer comprising a sulphonic acid monomer and an acrylic acid monomer.

The at least one polycarboxylate comprises a maleic acid monomer. Such a polymer is preferably present in an amount of from 0.1 to 5 wt., from 0.2 to 4.5% wt., from 0.3 to 4% wt., from 0.3 to 3.5% wt., from 0.4 to 3% wt., from 0.5 to 2.5% wt., from 0.6 to 2% wt., or from 0.7 to 1.5% wt.

The polymer may have a viscosity of from 500 to 3000 mPa·s, from 750 to 2500 mPa·s, from 1000 mPa·s to 2000 mPa·s. Such a copolymer may have a weight average molecular weight from 10,000 to 100,000 g mol⁻¹, from 20,000 to 80,000 g mol⁻¹, from 30,000 to 70,000 g mol⁻¹, or from 45,000 to 55,000 g mol⁻¹.

The polycarboxylate may be a copolymer comprising a maleic acid monomer and an acrylic acid monomer.

The acrylic acid-maleic acid copolymer may be formed from 2-propenoic acid and 2,5-furandione. The acrylic acid-maleic acid copolymer may have a pH of from 7 to 9, such as from 7.5 to 8.5, assessed by DIN19268.

The polymer may be an acrylic acid homopolymer, an acrylic acid-sulphonic acid, and/or an acrylic acid-maleic acid copolymer.

The polymer may comprise one or more polycarboxylate homopolymers and one or more polycarboxylate copolymers. The homopolymer(s) and copolymer(s) may be present in a ratio of from 1:20 to 1:2, preferably from 1:15 to 1:5.

The polymer may comprise polyepoxysuccinic acid (PESA) or derivatives thereof. Polyepoxysuccinic acid is also known as epoxysuccinic acid homopolymer, polyoxirane-2,3-dicarboxylic acid, 2,3-oxiranedicarboxylic acid homopolymer, or poly(1-oxacyclopropane-2,3-dicarboxylic acid); and has the general structure:

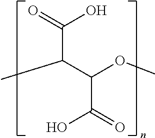

and where the derivatives thereof have the general structure:

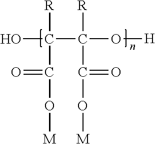

where R may be hydrogen or any organic chain (but preferably an ester such as C₁₋₄ alkyl) and where M may be any cation (preferably Na⁺, H⁺, K⁺, and/or NH₄⁺).

All references to PESA hereafter are to be taken to refer to polyepoxysuccinic acid or derivatives thereof, unless otherwise stated.

The PESA may have a weight average molecular weight from 100 to 10,000 g mol⁻¹, from 400 to 2000 g mol⁻¹, from 1000 to 1800 g mol⁻¹. The PESA may have from 2 to 100 repeating monomer units, such as from 2 to 50, 2 to 45, 2 to 20 or from 2 to 10 repeating monomer units.

The polymer may comprise PESA in an amount from 0.1 to 5% wt., from 0.1 to 4% wt., from 0.15 to 3% wt., from 0.2 to 1.9% wt., from 0.25 to 1.5% wt., or from 0.6 to 1.1% wt. PESA is preferably present in an amount from 5 to 20% wt., from 8 to 19% wt., or from 9 to 15% wt., relative to the total quantity of polymers present.

The polymer may comprise any biodegradable polymer.

The biodegradable polymer may comprise, for example, Alcoguard® H 5941.

The biodegradable polymer may comprise a bio-based carbohydrate backbone, for example starch, cellulose or inulin. The polymer may comprise one or more synthetic, fossil-based grafting group.

The polymer may be a cationic, anionic or amphoteric polymer.

The dishwashing, preferably automatic dishwashing, detergent composition of the present invention can comprise one or more surfactant(s). Any of nonionic, anionic, cationic, amphoteric or zwitterionic surface active agents or suitable mixtures thereof may be used. Many such suitable surfactants are described in Kirk Othmer's Encyclopedia of Chemical Technology, 3rd Ed., Vol. 22, pp. 360-379, “Surfactants and Detersive Systems”, incorporated by reference herein. Preferably, bleach-stable surfactants may be used.

In the case of automatic dishwashing compositions, it is preferred to minimise the amount of anionic surfactant. Accordingly, preferably the composition comprises no more than 15% wt., no more than 10% wt., no more than 5% wt., no more than 2% wt., no more than 1% wt., or no anionic surfactant. Preferably the composition comprises no more than 15% wt., no more than 10% wt., no more than 5% wt., no more than 2% wt., no more than 1% wt., or no ionic surfactant of any type.

Non-ionic surfactants are preferred for automatic dishwashing products. The composition may comprise from 5 to 25% wt., from 10 to 20% wt., from 11 to 19% wt., from 12 to 18% wt., from 13 to 17% wt., from 14 to 16% wt., or 15% wt. of one or more non-ionic surfactants.

The non-ionic surfactant may be an optionally end capped alkyl alkoxylate. A preferred class of non-ionic surfactants are ethoxylated non-ionic surfactants prepared by the reaction of a monohydroxy alkanol or alkyl phenol with 6 to 20 carbon atoms. Preferably the surfactants have at least 12 moles per mole of alcohol or alkyl phenol. Particularly preferred non-ionic surfactants are the nonionics from a linear chain fatty alcohol with 10-20 carbon atoms and at least 5 moles of ethylene oxide per mole of alcohol. The non-ionic surfactant may comprise propylene oxide (PO) units in the molecule. The PO units may constitute up to 40% wt., 35% wt., 30% wt., 25% wt., 20% wt. or up to 15% wt. of the overall molecular weight of the non-ionic surfactant.

The use of a mixture of any of the aforementioned non-ionic surfactants is suitable in compositions of the present invention.

The dishwashing, preferably automatic dishwashing, detergent composition of the present invention can comprise one or more enzymes. It is preferred that the one or more enzymes are selected from protease, lipase, amylase, cellulase and peroxidase, with protease and amylase being most preferred. It is most preferred that protease and/or amylase enzymes are included in the compositions according to the invention as such enzymes are especially effective in dishwashing detergent compositions.

The one or more enzyme may be present in an amount from 1 to 40% wt., from 2 to 38% wt., from 4 to 36% wt., from 6 to 34% wt., from 8 to 32% wt., from 10 to 30% wt., from 12 to 28% wt., from 14 to 26% wt., from 16 to 24% wt., from 18 to 24% wt. from 20 to 24% wt., from 22 to 24% wt., or 23% wt. based on the weight of the detergent composition.

The dishwashing, preferably automatic dishwashing, detergent composition of the present invention can comprise one or more bleaching agents, preferably in combination with one or more bleach activators and/or one or more bleach catalysts. The one or more bleaching agent is preferably selected from the group consisting of an oxygen-releasing bleaching agent, a chlorine-releasing bleaching agent and mixtures thereof.

The bleaching agent may comprise the active bleach species itself or a precursor to that species. The bleaching agent may be selected from the group consisting of an inorganic peroxide, an organic peracid and mixtures thereof. The terms “inorganic peroxide” and “organic peracid” encompass salts and derivatives thereof. Inorganic peroxides include percarbonates, perborates, persulphates, hydrogen peroxide and derivatives and salts thereof. The sodium and potassium salts of these inorganic peroxides are suitable, especially the sodium salts. Sodium percarbonate is particularly preferred.

The active bleaching agent is preferably present in an amount from 5 to 25% wt., from 7 to 23% wt., from 9 to 19% wt., or from 11 to 17% wt.

The detergent composition may further comprise one or more bleach activators and/or bleach catalysts. Any suitable bleach activator may be included, for example Tetraacetylethylenediamine (TAED), if this is desired for the activation of the bleaching agent. Any suitable bleach catalyst may be used, for example manganese acetate or dinuclear manganese complexes such as those described in EP 1741774 A1, the contents of which are incorporated herein by reference. The organic peracids such as perbenzoic acid and peroxycarboxylic acids e.g. phthalimidoperoxyhexanoic acid (PAP) do not require the use of a bleach activator or catalyst as these bleaches are active at relatively low temperatures such as 30° C.

The bleach catalyst may be a manganese complex comprising 1,4,7-Triazacyclononane (TACN), or any derivatives of a TACN ligand, for example 1,4,7-trimethyl-TACN, manganese oxalate, manganese acetate or a dinuclear manganese complex, for example a dinuclear manganese complex comprising TACN or any derivatives of a TACN ligand, for example 1,4,7-trimethyl-TACN.

Further, the object of the present invention is also solved by a dishwashing, preferably an automatic dishwashing, water-soluble container wherein said water-soluble container is made of a thermoformed water-soluble film comprising poly(vinyl alcohol) and wherein said water-soluble container is at least partially filled with such an inventive dishwashing, preferably an automatic dishwashing, detergent composition according to the present invention.

By the term “water-soluble container” as used herein, it is meant a container which at least partially dissolves in water or disperses in water at 20° C. within 10 minutes to allow for egress of the contents of the package into the surrounding water.

The thermoformed water-soluble film comprising poly(vinyl alcohol) may be rigid or flexible at room temperature.

Preferably, the poly(vinyl alcohol) film may be partially or fully alcoholised or hydrolysed, for example, it may be from 40 to 100%, preferably 70 to 92%, most preferably 85% to 92%, alcoholised or hydrolysed, polyvinyl acetate film. The degree of hydrolysis is known to influence the temperature at which the PVOH starts to dissolve in water. 88% hydrolysis corresponds to a film soluble in cold (i.e. room temperature of 20° C.) water, whereas 92% hydrolysis corresponds to a film soluble in warm water. The film may be cast, blown or extruded. It may further be unoriented, mono-axially oriented or bi-axially oriented.

In a preferred embodiment thereof, said water-soluble container comprises at least a first compartment and at least a, from the first compartment separated, second compartment; wherein said at least first compartment is at least partially filled with such an inventive dishwashing, preferably an automatic dishwashing, detergent composition according to the present invention in powder form.

Additionally, the object of the present invention is also solved by an autodosing automatic dishwashing system wherein said autodosing automatic dishwashing system comprises at least a first cartridge and at least a second cartridge arranged separated from each other inside of a dishwashing apparatus, wherein said at least first cartridge is at least partially filled with such an inventive automatic dishwashing detergent composition according to the present invention;
or alternatively wherein said autodosing automatic dishwashing system comprises a cartridge comprising at least a first cartridge compartment and at least a second cartridge compartment separated from each other inside of said cartridge, wherein said first cartridge compartment is at least partially filled with such an inventive automatic dishwashing detergent composition according to the present invention.

Additionally, the object of the present invention is also solved by making use of such an inventive dishwashing, preferably an automatic dishwashing, detergent composition according to the present invention for the prevention of discoloration of plastic dishes during a dishwashing, preferably during an automatic dishwashing, process.

Furthermore, the object of the present invention is also solved by a method of preventing plastic dishes from discoloration during a dishwashing process, the method comprising adding at least one water-soluble polyester to the automatic dishwashing detergent composition.

The following non-limiting examples are provided to illustrate an embodiment of the present invention and to facilitate understanding of the invention but are not intended to limit the scope of the invention, which is defined by the claims appended hereto.

### Experimental Conditions

### Dishwasher

A consumer-relevant dishwasher (Model: GE GDT605PSM0SS) was used for testing the effect of the polymers towards decreased discoloration of plastic items (red stains) during a dishwasher cycle. The dishwasher was used with the following program: time=1 h+heat program (main wash peak temperature: 55° C.) connected to 110 V/60 Hz electrical supply. Water hardness of 6.74° GH (120 ppm Ca/Mg) was employed.

### Dishwasher Loading (Ballast and Plastic Dishes)

The top and the bottom of the dishwasher trays were loaded with a selection of ballast dishes to represent ideal consumer-relevant conditions. The selection on the top tray was among plates (white, ceramic, quantity: 3-6), beakers (glass, transparent, quantity: 5-8), teacups (white, ceramic, quantity: 5-8) and in the bottom tray that of large plates (white, ceramic, quantity: 8-12), and regular plates (black, ceramic, quantity: 3-6). The relevant plastic dishes necessary for testing were also selected from a range of consumer-relevant plastic ware. The top tray was loaded with plastic containers (polypropylene, Tupperware, transparent, quantity: 2), container lid (LDPE, Tupperware, green, quantity: 2), and the bottom tray with LEGITIM cutting board (LDPE, white, manufactured by IKEA, quantity: 1).

### Red Stain

100 g of Heinz tomato ketchup (Production code: 20211932TK1) from the local grocery store was weighed into a beaker and placed inverted in the upper tray of the dishwasher.

### Testing Procedure

### Pre-Wash

As plastic items often have an initial coating on them preventing the adsorption of stains, all plastic items used for the tests were pre-washed using the benchmark detergent formulation F1 in one dishwasher cycle. Followed by this, the plastic ware was used for testing.

All ballast dishes and the plastic items were placed in the above-mentioned positions in the dishwasher. The ketchup stain in a beaker was also loaded into the dishwasher in the upper tray of the dishwasher. Lastly, the benchmark detergent and the polymer as the active were placed in the dosing chamber and one complete cycle was run before determining the effect of the polymer in preventing the red ketchup stain from depositing on the plastic items. After the dishwasher cycle, the plastic items were allowed to dry completely in a dark area and evaluated within 24 h. After every testing cycle, the dishwasher was cleaned with Neodisher LaboCleaner A8, descaled with citric acid, and finally re-conditioned with a benchmark detergent for the next test cycle.

### Evaluation of Plastic Discoloration

All transparent plastic items, namely the cutting board and the box, were evaluated using DigiEye (VeriVide, diffused light, calibrated for white and the full color palette) for their “Total Color Difference” (TCD) value. This was calculated using the following formula:

$$TCD = \frac{Δ {E}_{2}}{Δ {E}_{1}} * 100 \% = \frac{√ ( Δ {L}_{2}^{2} + Δ {a}_{2}^{2} + Δ {b}_{2}^{2} )}{√ ( Δ {L}_{1}^{2} + Δ {a}_{1}^{2} + Δ {b}_{1}^{2} )} * 100 \% ;$$

where,
ΔE2 is the color difference between the unstained plastic and that of plastic stained using only the benchmark detergent+polymer
ΔE1 is the color difference between the unstained plastic and that of plastic stained using the benchmark detergent
And ΔL, Δa, and Δb are color values stored by DigiEye in the LAB color scale.

Herein, the lower the respective resulting TCD values are, the better the protection against plastic discoloration is. Thus, a smaller TCD value represent a better protection against staining.

### Experimental Results

TABLE 1
Comparative and inventive formulations.

| | Formulation | | | | | | | |
|---|---|---|---|---|---|---|---|---|
| | F1 | F2 | F3 | F4 | F5 | F6 | F7 | F8 |
| Ingredients (wt %) | Comp. | Comp. | Comp. | Comp. | Inv. | Inv. | Comp. | Inv. |
| Sodium percarbonate | 8.0% | 14.2% | — | 8.0% | 8.0% | 8.0% | 8.0% | 8.0% |
| TAED | 4.0% | 0.7% | — | 4.0% | 4.0% | 4.0% | 4.0% | 4.0% |
| Manganese bleach | 0.02% | — | — | 0.02% | 0.02% | 0.02% | 0.02% | 0.02% |
| catalyst | | | | | | | | |
| Tetrasodium-HEDP | 0.6% | 8.6% | — | 0.6% | 0.6% | 0.6% | 0.6% | 0.6% |
| Polycarboxylate | 4.3% | 3.2% | — | 4.3% | 4.3% | 4.3% | 4.3% | 4.3% |
| Sulfonated polymer | — | 7.8% | — | — | — | — | — | — |
| Citrate trisodium | — | 21.9% | — | — | — | — | — | — |
| dihydrate | | | | | | | | |
| Sodium disilicate | — | 1.4% | — | — | — | — | — | — |
| Sodium carbonate | 31.0% | 15.4% | — | 31.0% | 31.0% | 31.0% | 31.0% | 31.0% |
| Sodium bicarbonate | 6.7% | 3.0% | | 6.7% | 6.7% | 6.7% | 6.7% | 6.7% |
| PEG | 3.6% | 8.0% | — | 3.6% | 3.6% | 3.6% | 3.6% | 3.6% |
| Glycerol | — | 0.07% | — | — | — | — | — | — |
| Enzyme(s) | 1.6% | 1.0% | — | 1.6% | 1.6% | 1.6% | 1.6% | 1.6% |
| Non-ionic surfactant | 14.2% | 5.8% | — | 14.2% | 14.2% | 14.2% | 14.2% | 14.2% |
| Polymer (comparative | — | — | — | B | D | F | A | C |
| or inventive) | | | | (1.7%) | (1.7%) | (1.7%) | (3.5%) | (3.5%) |
| Red stain - Ketchup | 100 g | 100 g | 100 g | 100 g | 100 g | 100 g | 100 g | 100 g |
| IKW soil | — | — | — | — | — | — | — | — |
| TCD (%, board) | 101 | 104 | 195 | 73 | 24 | 55 | 79 | 24 |

TABLE 2
Further comparative and inventive formulations.

| | Formulation | | | | | | | |
|---|---|---|---|---|---|---|---|---|
| | F9 | F10 | F11 | F12 | F13 | F14 | F15 | F16 |
| Ingredients (wt %) | Inv. | Comp. | Inv. | Inv. | Comp. | Inv. | Inv. | Inv. |
| Sodium percarbonate | 8.0% | 14.2% | 14.2% | 14.2% | 8.0% | 8.0% | 8.0% | 8.0% |
| TAED | 4.0% | 0.7% | 0.7% | 0.7% | 4.0% | 4.0% | 4.0% | 4.0% |
| Manganese bleach | 0.02% | — | — | — | 0.02% | 0.02% | 0.02% | 0.02% |
| catalyst | | | | | | | | |
| Tetrasodium-HEDP | 0.6% | 8.6% | 8.6% | 8.6% | 0.6% | 0.6% | 0.6% | 0.6% |
| Polycarboxylate | 4.3% | 3.2% | 3.2% | 3.2% | 4.3% | 4.3% | 4.3% | 4.3% |
| Sulfonated polymer | — | 7.8% | 7.8% | 7.8% | — | — | — | — |
| Citrate trisodium | — | 21.9% | 21.9% | 21.9% | — | — | — | — |
| dihydrate | | | | | | | | |
| Sodium disilicate | — | 1.4% | 1.4% | 1.4% | — | — | — | — |
| Sodium carbonate | 31.0% | 15.4% | 15.4% | 15.4% | 31.0% | 31.0% | 31.0% | 31.0% |
| Sodium bicarbonate | 6.7% | 3.0% | 3.0% | 3.0% | 6.7% | 6.7% | 6.7% | 6.7% |
| PEG | 3.6% | 8.0% | 8.0% | 8.0% | 3.6% | 3.6% | 3.6% | 3.6% |
| Glycerol | — | 0.07% | 0.07% | 0.07% | — | — | — | — |
| Enzymes(s) | 1.6% | 1.0% | 1.0% | 1.0% | 1.6% | 1.6% | 1.6% | 1.6% |
| Non-ionic surfactant | 14.2% | 5.8% | 5.8% | 5.8% | 14.2% | 14.2% | 14.2% | 14.2% |
| Polymer (comparative | E | B | D | F | A | C | E | G |
| or inventive) | (3.5%) | (1.5%) | (1.5%) | (1.5%) | (3.5%) | (3.5%) | (3.5%) | (3.5%) |
| Red stain - Ketchup | 100 g | 100 g | 100 g | 100 g | 50 g | 50 g | 50 g | 50 g |
| IKW soil | — | — | — | — | 50 g | 50 g | 50 g | 50 g |
| TCD (%, board) | 66 | 103 | 42 | 63 | 98 | 31 | 65 | 29 |

A considerable reduction in color transfer from the red stain (ketchup) on plastic boards has been demonstrated against the benchmark formulations F1, F2 and F3 (all without a specific polymer) and against the comparative examples having Sokalan CP9® (F4, F7, F10 and F13) as an alternative comparative polymer comprised.

Texcare SRA 300F® and Repel-o-Tex SF-2® have shown their effectiveness and superior performance over non-ionic variants even when both are still much better than the comparative formulations without any specific polymers or with another alternative polymer not being a water-soluble polyester.

TABLE 3
Polymers used in the examples

| Polymer | Inventive polymer against plastic |
|---|---|
| composition | discoloration |
| A (Comp.) | Sokalan CP9 ® |
| B (Comp.) | Sokalan CP9 ® |
| C (Inv.) | Texcare SRA 300F ® |
| D (Inv.) | Texcare SRA 300F ® |
| E (Inv.) | Texcare SRN 300 ® |
| F (Inv.) | Texcare SRN 300 ® |
| G (Inv.) | Repel-O-Tex SF2 ® |

Herein, Sokalan CP9® is a copolymer of maleic acid and diisobutene sodium salt.

Texcare SRA 300F® is a sulfonated, aromatic, water-soluble polyester. It is a polycondensate of terephthalic acid, 5-sulfoisophthalic acid, propylene glycol and ethylene glycol and their polymeric polyethers with a number average molecular weight below 15 000 g/mol.

Texcare SRN 300® is a nonionic variant of Texcare SRA 300FR.

Repel-o-Tex SF-2® is a sulfonated, hydrophilic aromatic polyester similar to Texcare SRA 300F®.

This invention demonstrates the successful use of water-soluble polyesters for protection against plastic discoloration during a dishwashing cycle. The superior benefits of this specific class of polymers even at low concentrations in detergent formulations have been shown. A significant improvement in the extent of discoloration of plastic items compared to that of the benchmark formulations is evident.

The present invention thus addresses the problem of offering a dishwashing detergent composition comprising a water-soluble polyester; wherein said dishwashing detergent composition can be used for monodose detergent products as well as for autodosing automatic dishwashing processes; in particular for the prevention of discoloration of plastic items during the dishwasher cycle.

It will be understood that the embodiments described herein are merely exemplary and that a person skilled in the art may make many variations and modifications without departing from the spirit and scope of the invention. All such variations and modifications, including those discussed above, are intended to be included within the scope of the invention as defined by the appended claims.

1. A dishwashing detergent composition characterized in that the detergent composition comprises a water-soluble polyester.

2. The dishwashing detergent composition according to claim 1 characterized in that said water-soluble polyester is a water-soluble aromatic polyester.

3. The dishwashing detergent composition according to claim 2 characterized in that said water-soluble aromatic polyester is obtained by a reaction of at least one diol with at least one aromatic diacid or a derivative thereof.

4. The dishwashing detergent composition according to claim 2 characterized in that said water-soluble aromatic polyester is obtained by a reaction of at least one diol with at least two different aromatic diacid or derivatives thereof.

5. The dishwashing detergent composition according to claim 3 characterized in that said at least one diol is selected from the group consisting of ethylene glycol, propylene glycol, butylene glycol, polyethylene glycol, polypropylene glycol and polybutylene glycol.

6. The dishwashing detergent composition according to one of the preceding claim 3 characterized in that said at least one aromatic diacid derivative comprises one or two ester groups, one or two anhydride groups, one or two carboxylic acid salt groups, and/or one or two carboxylic acid chloride groups instead of one or two respective carboxylic acid groups of the respective aromatic diacid.

7. The dishwashing detergent composition according to claim 6 characterized in that said at least one aromatic diacid or a derivative thereof is selected from the group consisting of terephthalic acid, isoterepthalic acid, isophthalic acid, phthalic acid, 5-sulfoisophthalic acid, 5-sulfoisoterephthalic acid, 5-sulfoterephthalic acid, and 5-sulfophthalic acid.

8. The dishwashing detergent composition according to claim 7 characterized in that one aromatic diacid or a derivative thereof of said at least one aromatic diacid or a derivative thereof is selected from the group consisting of 5-sulfoisophthalic acid, 5-sulfoisoterephthalic acid, 5-sulfoterephthalic acid, or 5-sulfophthalic acid.

9. The dishwashing detergent composition according to claim 2 characterized in that said water-soluble aromatic polyester comprises at least one substitution of at least one hydrogen atom at the aromatic ring by one sulfate group, by one sulfonic acid group, or by one anionic sulfonic acid group with a respective suitable counterion.

10. The dishwashing detergent composition according to claim 1 characterized in that said polyester has a number average molecular weight ranging from 2500 to 25000 g/mol.

11. The dishwashing detergent composition according to claim 1 characterized in that said dishwashing detergent composition comprises 0.5 to 10 wt % of said water-soluble polyester.

12. A dishwashing water-soluble container characterized in that said water-soluble container is made of a thermoformed water-soluble film comprising poly(vinyl alcohol) and wherein said water-soluble container is at least partially filled with a dishwashing detergent composition according to claim 1.

13. The dishwashing water-soluble container according to claim 12 characterized in that said water-soluble container comprises at least a first compartment and at least a, from the first compartment separated, second compartment; wherein said at least first compartment is at least partially filled with the dishwashing detergent composition in powder form.

14. An autodosing automatic dishwashing system characterized in that said autodosing automatic dishwashing system comprises at least a first cartridge and at least a second cartridge arranged separated from each other inside of a dishwashing apparatus, wherein said at least first cartridge is at least partially filled with an automatic dishwashing detergent composition according to claim 1;
or alternatively characterized in that said autodosing automatic dishwashing system comprises a cartridge comprising at least a first cartridge compartment and at least a second cartridge compartment separated from each other inside of said cartridge, wherein said first cartridge compartment is at least partially filled with an automatic dishwashing detergent composition according to claim 1.

15. (canceled)

16. The dishwashing detergent composition according to claim 4 characterized in that said at least one diol is selected from the group consisting of ethylene glycol, propylene glycol, butylene glycol, polyethylene glycol, polypropylene glycol and polybutylene glycol.

17. The dishwashing detergent composition according to claim 6 characterized in that said at least one aromatic diacid derivative comprises at least one or two methyl ester groups instead of one or two respective carboxylic acid groups of the respective aromatic diacid.

18. The Dishwashing detergent composition according to claim 4 characterized in that each of said at least two different aromatic diacid derivatives comprises one or two ester groups, one or two anhydride groups, one or two carboxylic acid salt groups, and/or one or two carboxylic acid chloride groups instead of one or two respective carboxylic acid groups of the respective aromatic diacid.

19. The dishwashing detergent composition according to claim 18 characterized in that each of said at least two different aromatic diacid derivative comprises at least one or two methyl ester groups instead of one or two respective carboxylic acid groups of the respective aromatic diacid.

20. The dishwashing detergent composition according to claim 18 characterized in that each of said at least two different aromatic diacid or a derivative thereof is selected from the group consisting of terephthalic acid, isoterepthalic acid, isophthalic acid, phthalic acid, 5-sulfoisophthalic acid, 5-sulfoisoterephthalic acid, 5-sulfoterephthalic acid, and 5-sulfophthalic acid.

21. The dishwashing detergent composition according to claim 20 characterized in that each of said at least two different aromatic diacid or a derivative thereof of said at least one aromatic diacid or a derivative thereof is selected from the group consisting of 5-sulfoisophthalic acid, 5-sulfoisoterephthalic acid, 5-sulfoterephthalic acid, or 5-sulfophthalic acid.
